(19) United States
(12) Patent Application Publication
(10) Pub. No.: US 2025/0372917 A1
(43) Pub. Date: Dec. 4, 2025

(54) CONNECTOR AND CONNECTOR ASSEMBLY

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Nungna WI, Mie (JP); Teruo HARA, Mie (JP)

(21) Appl. No.: 18/875,165

(22) PCT Filed: Jun. 7, 2023
(86) PCT No.: PCT/JP2023/021145

§ 371 Date: Dec. 16, 2024

(30) Foreign Application Priority Data
Jun. 23, 2022 (JP) 2022-100832

(51) Int. Cl. H01R 13/52; H01R 4/70; H01R 107/00

(52) U.S. Cl. CPC H01R 13/52; H01R 4/70; H01R 2107/00

(57) ABSTRACT

A connector is connected to a second wire and includes a first wire, a terminal, a rubber plug, and a housing for accommodating the rubber plug. The first wire includes a first core wire and a first insulation coating covering the first core wire. The second wire includes a second core wire and a second insulation coating covering the second core wire. The terminal includes a first connecting portion to be connected to the first core wire and a second connecting portion to be connected to the second core wire. The rubber plug is formed with a cavity extending in a first direction, the terminal, the first wire and the second wire being inserted inside the cavity.

### TECHNICAL FIELD

The present disclosure relates to a connector and a connector assembly.

### BACKGROUND

A connector described in Japanese Patent Laid-Open Publication No. 2020-187997 (Patent Document 1 below) is conventionally known as a connector for connecting two wires without using a crimping terminal. This connector includes a female connector and a male connector to be connected to each other. The female connector is provided with a female housing, a connecting device accommodated in the female housing and a first coated wire. The male connector is provided with a male housing and a second coated wire.

The connecting device is a device for connecting the first and second coated wires. The connecting device is provided with a movable-side conductive member and a fixed-side conductive member for electrically contacting a first conductor of the first coated wire and a second conductor of the second coated wire from sides opposite to each other and a pressing member for pressing the movable-side conductive member and the fixed-side conductive member against the first conductor and the second conductor in a contact direction.

### PRIOR ART DOCUMENT

### Patent Document

Patent Document 1: JP 2020-187997 A

### SUMMARY OF THE INVENTION

### Problems to be Solved

In the above connector, waterproofness is not considered. Thus, water may intrude into the connector, for example, from connection surfaces of the female connector and the male connector. Further, if a sealing member is simply added to the above configuration, the number of components increases.

### Means to Solve the Problem

The present disclosure is directed to a connector to be connected to a second wire, the connector being provided with a first wire, a terminal, a rubber plug and a housing for accommodating the rubber plug, the first wire including a first core wire and a first insulation coating covering the first core wire, the second wire including a second core wire and a second insulation coating covering the second core wire, the terminal including a first connecting portion to be connected to the first core wire and a second connecting portion to be connected to the second core wire, the rubber plug being formed with a cavity extending in a first direction, the terminal, the first wire and the second wire being inserted inside the cavity, and a first sealing portion disposed on one side in the first direction with respect to the terminal to seal an outer peripheral surface of the first insulation coating and a second sealing portion disposed on the other side in the first direction with respect to the terminal to seal an outer peripheral surface of the second insulation coating being formed on an inner peripheral surface of the cavity.

### Effect of the Invention

According to the present disclosure, it is possible to provide a waterproof connector having a simple configuration.

### BRIEF DESCRIPTION OF THE DRAWINGS

FIG. 1 is a perspective view of a connector according to an embodiment.

FIG. 2 is an exploded perspective view of a connector assembly.

FIG. 3 is a perspective view of a mating connector.

FIG. 4 is a perspective view of the connector.

FIG. 5 is a back view of the connector.

FIG. 6 is a section along A-A of FIG. 5.

FIG. 7 is a section along B-B of FIG. 5.

FIG. 8 is a section along C-C of FIG. 6.

FIG. 9 is a section of the connector assembly in a cross-section along A-A of FIG. 5.

FIG. 10 is a section of the connector assembly in a cross-section along C-C of FIG. 6.

FIG. 11 is a plan view of a first wire module.

FIG. 12 is a section along D-D of FIG. 11.

FIG. 13 is a perspective view of a rubber plug.

FIG. 14 is a perspective view of a terminal.

FIG. 15 is a side view of the terminal.

FIG. 16 is a section along E-E of FIG. 15.

FIG. 17 is a front perspective view of a rear holder.

FIG. 18 is a rear perspective view of the rear holder.

### DETAILED DESCRIPTION TO EXECUTE THE INVENTION

### Description of Embodiments of Present Disclosure

First, embodiments of the present disclosure are listed and described.

(1) The connector of the present disclosure is to be connected to a second wire and provided with a first wire, a terminal, a rubber plug and a housing for accommodating the rubber plug, the first wire including a first core wire and a first insulation coating covering the first core wire, the second wire including a second core wire and a second insulation coating covering the second core wire, the terminal including a first connecting portion to be connected to the first core wire and a second connecting portion to be connected to the second core wire, the rubber plug being formed with a cavity extending in a first direction, the terminal, the first wire and the second wire being inserted inside the cavity, and a first sealing portion disposed on one side in the first direction with respect to the terminal to seal an outer peripheral surface of the first insulation coating and a second sealing portion disposed on the other side in the first direction with respect to the terminal to seal an outer peripheral surface of the second insulation coating being formed on an inner peripheral surface of the cavity.

According to this configuration, since the terminal, the first wire and the second wire are inserted into the cavity of the rubber plug and the first and second sealing portions are provided on the inner peripheral surface of the cavity, the connector can be provided with waterproofness while an increase in the number of components is suppressed.

(2) Preferably, the rubber plug includes a locking projection projecting inwardly of the cavity from the inner peripheral surface of the cavity, and the terminal includes a locking recess to be locked to the locking projection.

According to this configuration, the terminal is easily held in the cavity by locking the locking projection and the locking recess.

(3) Preferably, the rubber plug includes a projection projecting from an outer peripheral surface of the rubber plug to contact an inner peripheral surface of the housing.

According to this configuration, a contact area of the outer peripheral surface of the rubber plug and the inner peripheral surface of the housing can be reduced by providing the projection on the outer peripheral surface of the rubber plug. Thus, an insertion force for inserting the rubber plug into the housing can be reduced.

(4) Preferably, the housing includes a rubber plug accommodating portion for accommodating the rubber plug and a rear holder for retaining the rubber plug inside the rubber plug accommodating portion by being assembled with the rubber plug accommodating portion from the one side in the first direction.

According to this configuration, the rubber plug is easily accommodated into the housing.

(5) Preferably, the housing includes a first wire holding portion for holding the first wire by being assembled with the rear holder.

According to this configuration, the first wire is easily held in the housing.

(6) Preferably, the first core wire and the second core wire are single-core wires.

According to this configuration, since the first and second core wires are single-core wires, the insertion of the first and second core wires into the cavity is facilitated.

(7) Preferably, the terminal includes a tubular portion long in the first direction and a projecting portion projecting inwardly of the tubular portion from an inner surface of the tubular portion, and the first and second connecting portions include the projecting portion.

According to this configuration, the terminal, the first core wire and the second core wire are easily connected by inserting the first and second core wires into the tubular portion. Further, since the first and second connecting portions are configured to include the projecting portion, contact areas of the first and second core wires with the inner surface of the tubular portion can be reduced. Thus, insertion forces for inserting the first and second core wires into the tubular portion can be reduced.

(8) A connector assembly of the present disclosure is provided with the above connector and a mating connector to be connected to the connector, the mating connector including the second wire and a mating housing for holding the second wire.

According to this configuration, the connector assembly can be provided with waterproofness while an increase in the number of components is suppressed.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

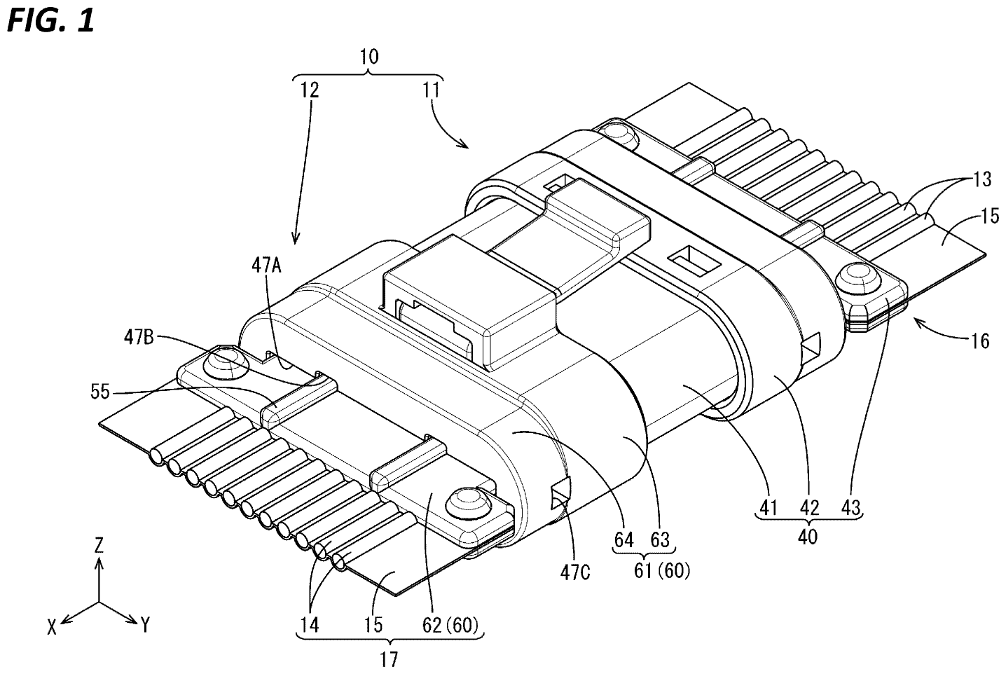

The embodiment of the present disclosure is described with reference to FIGS. 1 to 18. In the following description, a direction indicated by an arrow Z is referred to as an upward direction, a direction indicated by an arrow X is referred to as a forward direction and a direction indicated by an arrow Y is referred to as a leftward direction. In this embodiment, a front-rear direction is an example of a first direction. Note that, for a plurality of identical members, only some members may be denoted by a reference sign and the other members may not be denoted by the reference sign.

### Connector Assembly

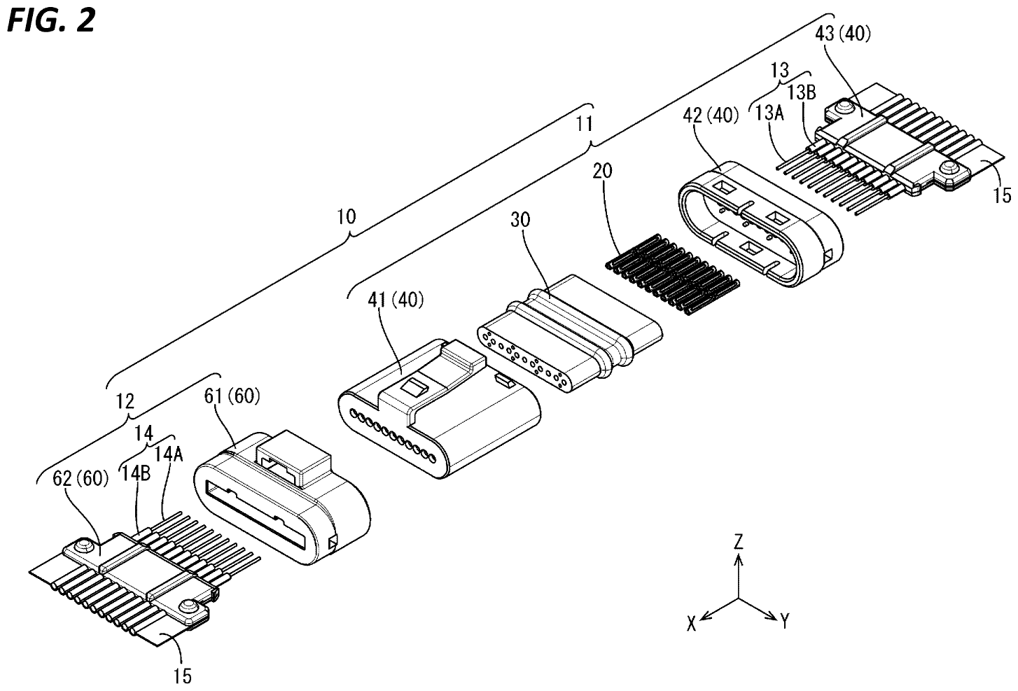

A connector assembly 10 of this embodiment is, as shown in FIGS. 1 and 2, provided with a connector 11 and a mating connector 12 to be connected to the connector 11. The connector assembly 10 is a waterproof connector assembly.

### Connector, Mating Connector

As shown in FIG. 2, the connector 11 is provided with first wires 13, terminals 20 to be connected to the first wires 13, a rubber plug 30 and a housing 40 for accommodating the rubber plug 30. The mating connector 12 is provided with second wires 14 and a mating housing 60 for holding the second wires 14. By inserting the second wire 14 into the terminal 20, the first and second wires 13, 14 are connected.

### First Wire, Second Wire

The first wire 13 is provided with a first core wire 13A and a first insulation coating 13B covering the outer periphery of the first core wire 13A. In this embodiment, the first core wire 13A is a single-core wire. The second wire 14 is provided with a second core wire 14A and a second insulation coating 14B covering the outer periphery of the second core wire 14A. In this embodiment, the second core wire 14A is a single-core wire.

### First Wire Holding Portion

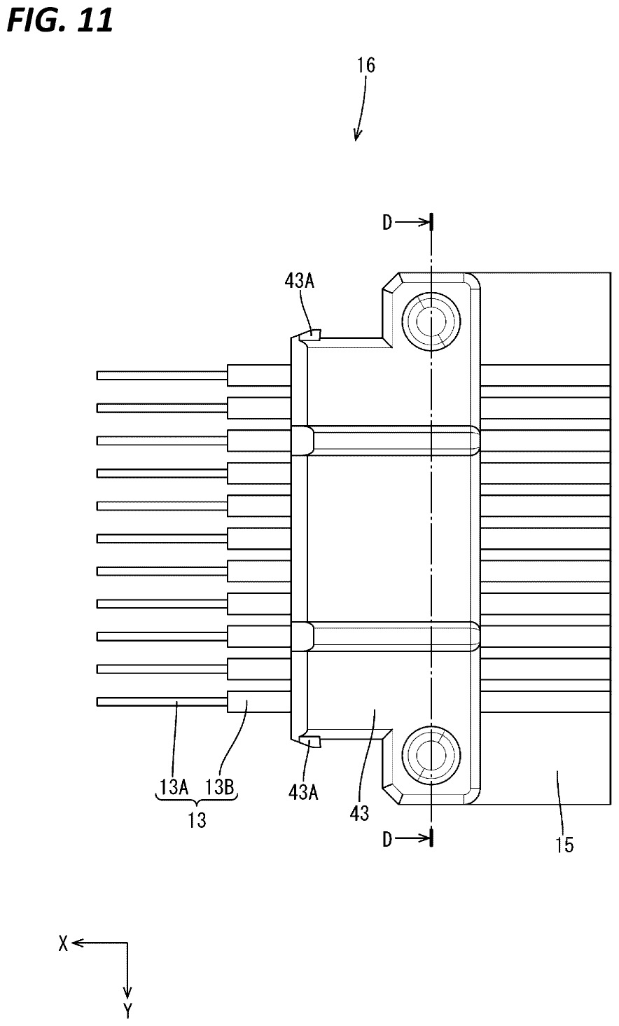

The connector 11 is provided with a plurality of the first wires 13. The plurality of first wires 13 are fixed to a fixing member 15 such as a nonwoven fabric while being arranged in a direction (lateral direction) orthogonal to an extension direction of the first wires 13. The plurality of first wires 13 fixed to the fixing member 15 are further held by a first wire holding portion 43. The first wire holding portion 43 is made of insulating synthetic resin. The first wire holding portion 43 is included in the housing 40 of this embodiment. As shown in FIG. 11, the first wire holding portion 43 includes locking portions 43A laterally projecting from both side parts of a front side of the first wire holding portion 43. The plurality of first wires 13, the fixing member 15 and the first wire holding portion 43 constitute a first wire module 16.

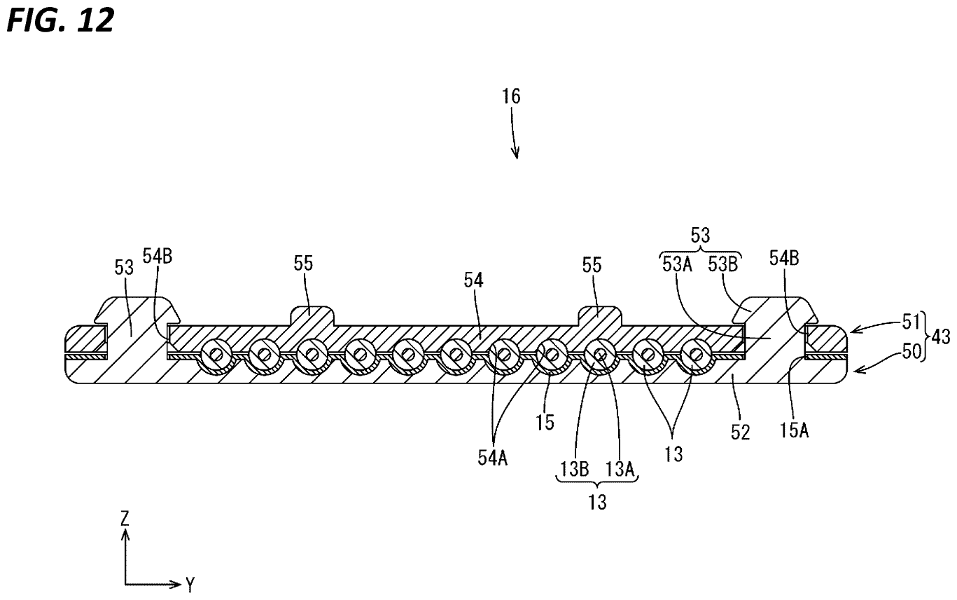

As shown in FIG. 12, the first wire holding portion 43 is provided with a lower holding portion 50 integrally formed with the plurality of first wires 13 fixed to the fixing member 15 and an upper holding portion 51 for sandwiching the plurality of first wires 13 together with the lower holding portion 50. The lower holding portion 50 includes a lower plate portion 52 to be disposed below the fixing member 15 and holding projections 53 extending upward from the lower plate portion 52. The holding projections 53 are disposed on both left and right sides of the lower plate portion 52. The holding projection 53 includes a shaft portion 53A and an enlarged diameter portion 53B disposed on the upper end of the shaft portion 53A and enlarged outward in diameter from the shaft portion 53A. The shaft portion 53A is inserted into a through hole 15A provided in the fixing member 15. The enlarged diameter portion 53B is formed into a tapered shape.

The upper holding portion 51 includes an upper plate portion 54 and two ridge portions 55 projecting upward from the upper plate portion 54 and extending in the front-rear direction. Wire receiving portions 54A recessed along the outer peripheral surfaces of the first wires 13 are formed in the lower surface of the upper plate portion 54. The upper holding portion 51 is provided with insertion holes 54B penetrating through the upper plate portion 54 in the vertical direction. The shaft portion 53A of the holding projection 53 is inserted into the insertion hole 54B. The inner wall of the insertion hole 54B is inclined to increase an inner diameter of the insertion hole 54B toward a lower side. In this way, the enlarged diameter portion 53B of the holding projection 53 is easily inserted into the insertion hole 54B. With the lower and upper holding portions 50, 51 assembled, the first wires 13 are held by the lower plate portion 52 and the wire receiving portions 54A. A hole edge part of the insertion hole 54B disposed in the upper surface of the upper plate portion 54 is in contact with the enlarged diameter portion 53B.

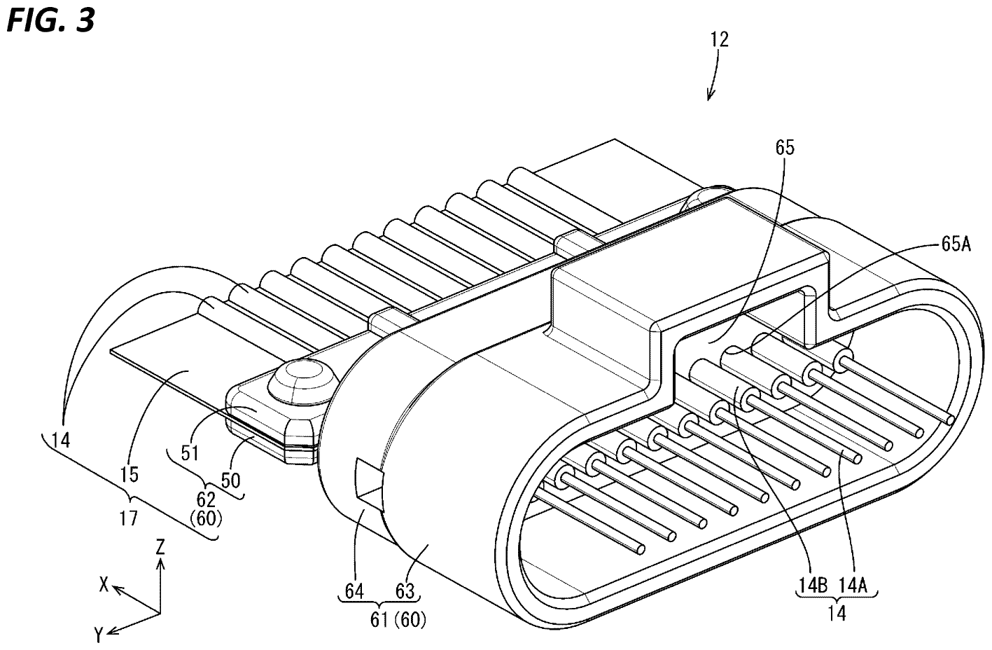

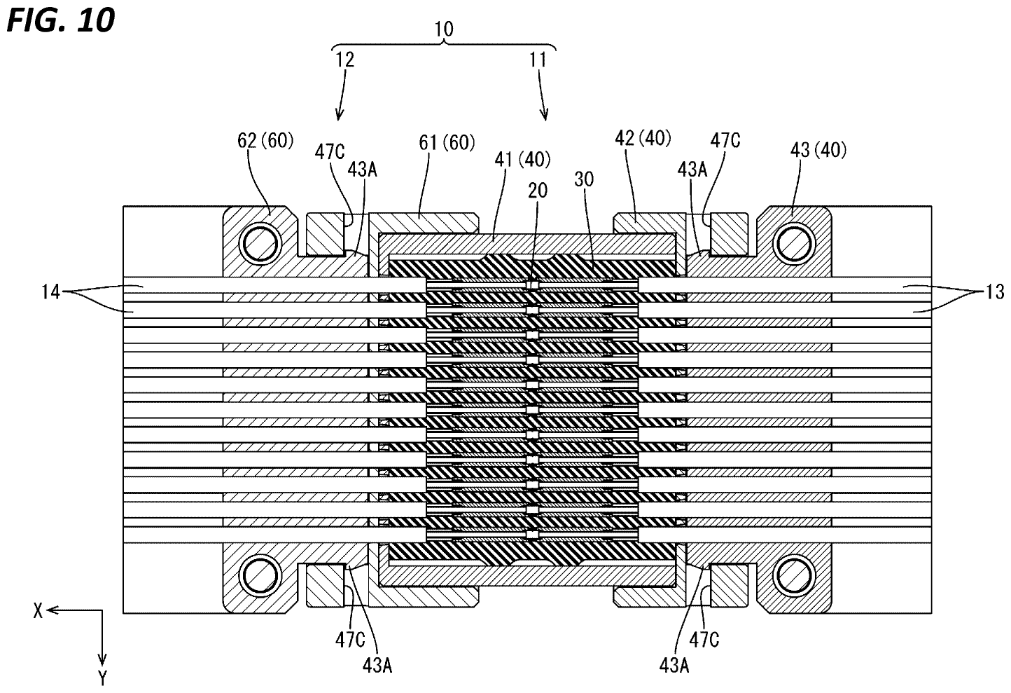

As shown in FIG. 3, the mating connector 12 is provided with a plurality of the second wires 14. Similarly to the first wires 13, the second wires 14 are held by a fixing member 15 and a second wire holding portion 62. The second wire holding portion 62 is configured similarly to the first wire holding portion 43 and includes locking portions 43A (see FIG. 10), a lower holding portion 50 and an upper holding portion 51. The second wire holding portion 62 is included in the mating housing 60 of this embodiment. The plurality of second wires 14, the fixing member 15 and the second wire holding portion 62 constitute a second wire module 17.

### Terminal

The terminal 20 is formed, such as by press-working an electrically conductive metal plate material. An arbitrary metal such as copper, copper alloy, aluminum, aluminum alloy or stainless steel can be appropriately selected as a metal constituting the terminal 20 if necessary. A plating layer may be formed on the surface of the terminal 20. An arbitrary metal such as tin, nickel or silver can be appropriately selected as a metal constituting the plating layer if necessary.

### Tubular Portion, Locking Recess

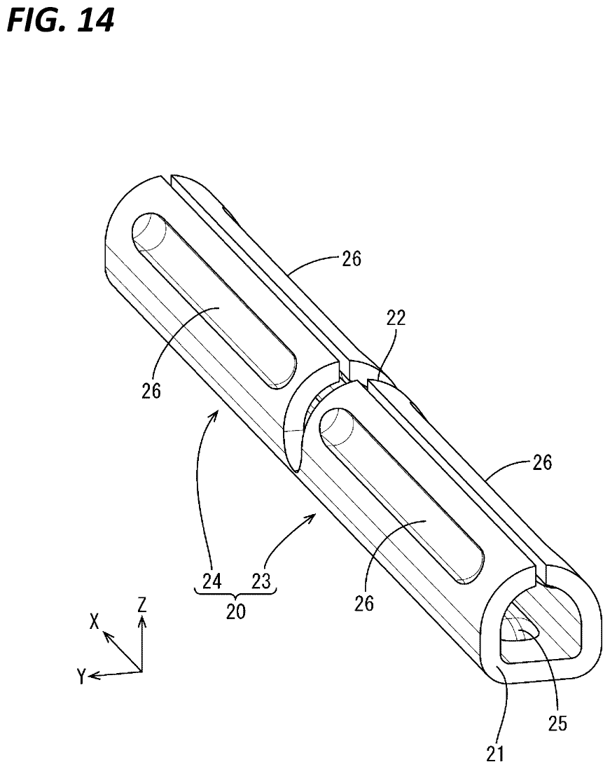

As shown in FIG. 14, the terminal 20 includes a tubular portion 21 having a tubular shape. In particular, the terminal 20 is shaped by bending both left and right side edges of the metal plate material toward each other on an upper side. The locking recess 22 is formed at a center position in the front-rear direction of the tubular portion 21. The locking recess 22 is in the form of a slit by cutting left and right side walls of the tubular portion 21.

### First Connecting Portion, Second Connecting Portion

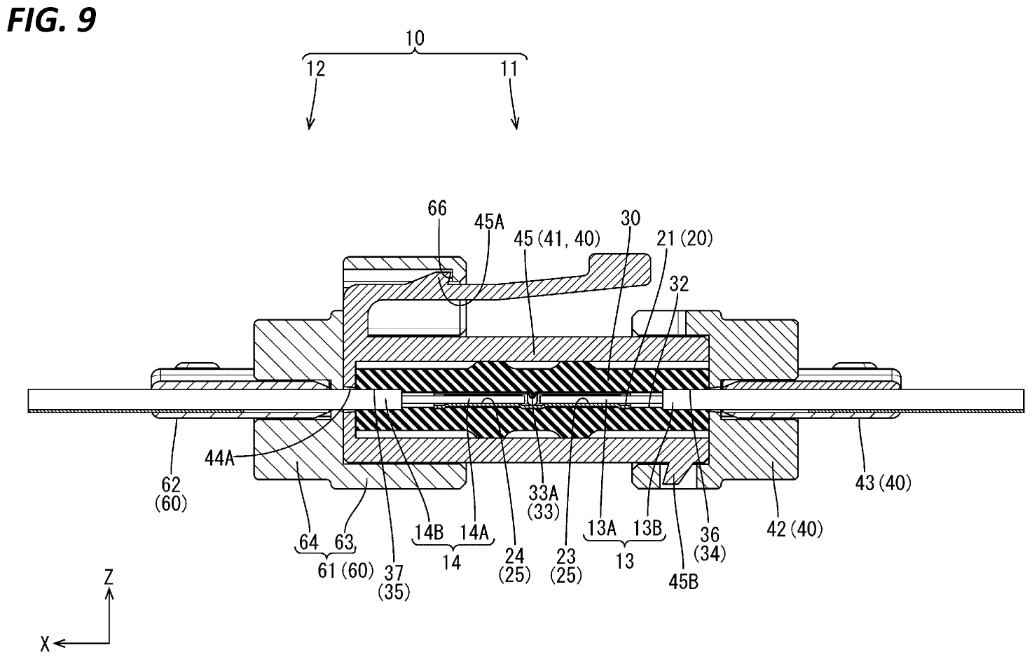

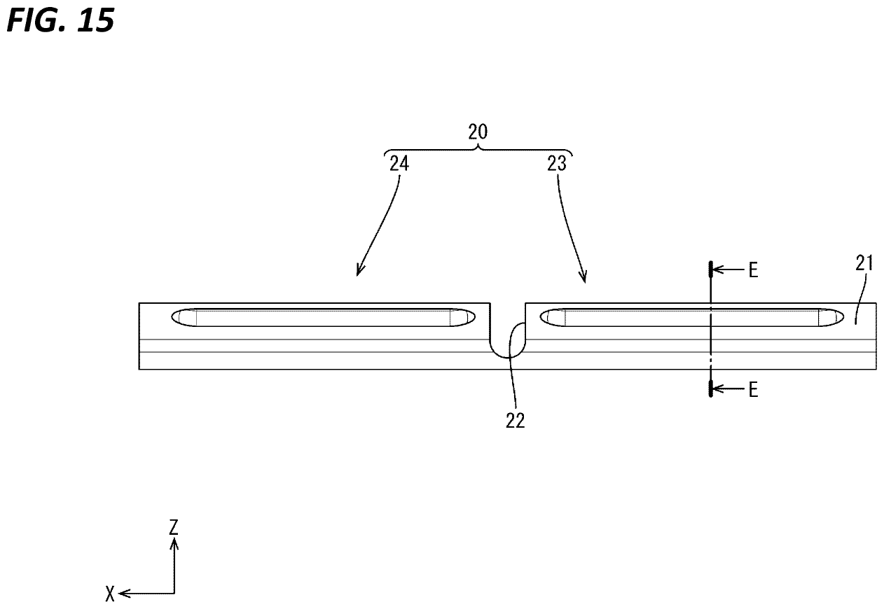

As shown in FIG. 15, the terminal 20 is provided with a first connecting portion 23 and a second connecting portion 24. In this embodiment, the first connecting portion 23 is provided in the tubular portion 21 behind the locking recess 22, and the second connecting portion 24 is provided in the tubular portion 21 in front of the locking recess 22. As shown in FIG. 9, the first connecting portion 23 is connected to the first core wire 13A. The second connecting portion 24 is connected to the second core wire 14A.

### Projecting Portion

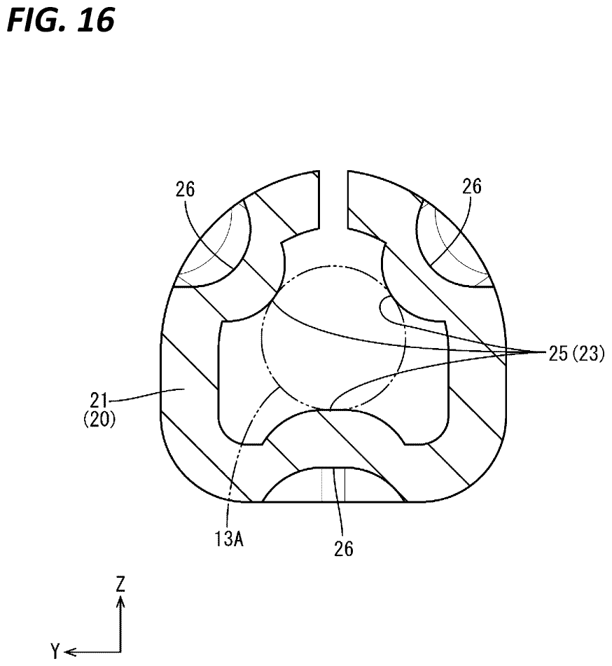

As shown in FIGS. 14 and 16, projecting portions 25 projecting inwardly of the tubular portion 21 are provided on the inner surface of the tubular portion 21. The projecting portions 25 of this embodiment are formed by striking the tubular portion 21 inwardly. Thus, recesses 26 recessed inwardly of the tubular portion 21 are formed at positions corresponding to the projecting portions 25 on the outer surface of the tubular portion 21. The recesses 26 and the projecting portions 25 extend in the front-rear direction. As shown in FIG. 16, the first connecting portion 23 is composed of three projecting portions 25 in this embodiment. The first core wire 13A (one-dot chain line of FIG. 16) is surrounded by the three projecting portions 25 and held in line or surface contact with the three projecting portions 25, whereby the first core wire 13A and the terminal 20 are electrically connected.

Similarly to the first connecting portion 23, the second connecting portion 24 is composed of three projecting portions 25. The second core wire 14A is surrounded by the three projecting portions 25 and held in line or surface contact with the three projecting portions 25, whereby the second core wire 14A and the terminal 20 are electrically connected.

By providing the first and second connecting portions 23, 24 with the projecting portions 25, contact areas of the first and second core wires 13A, 14A with the inner surface of the tubular portion 21 can be reduced. Thus, insertion forces for inserting the first and second core wires 13A, 14A into the tubular portions 21 can be reduced.

### Rubber Plug

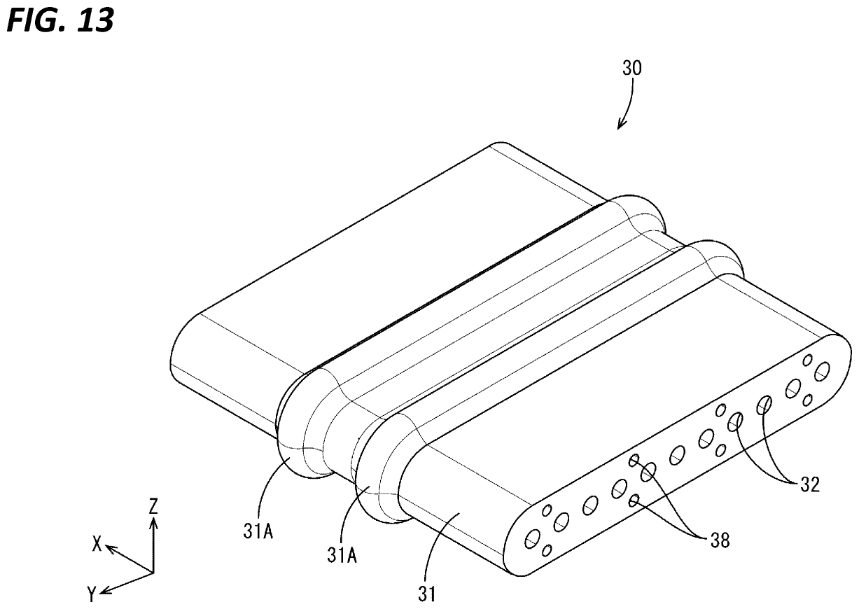

The rubber plug 30 is, for example, made of silicone rubber or the like. As shown in FIG. 13, the rubber plug 30 has a substantially elliptical cylindrical shape. The rubber plug 30 includes a body portion 31 and two projections 31A projecting outward from the outer peripheral surface of the body portion 31. The projection 31A is provided to circle around the outer periphery of the body portion 31. The rubber plug 30 is formed with a plurality of cavities 32 penetrating through the body portion 31 in the front-rear direction.

### Cavity

As shown in FIG. 9, the terminal 20, the first wire 13 and the second wire 14 are inserted into each cavity 32. That is, a terminal accommodating portion 33 for accommodating the terminal 20, a first wire inserting portion 34, into which the first wire 13 is inserted, and a second wire inserting portion 35, into which the second wire 14 is inserted, are provided one after another in the same cavity 32. The terminal accommodating portion 33 is provided at a center position in the front-rear direction of the cavity 32. The first wire inserting portion 34 is provided in a rear part of the cavity 32. The second wire inserting portion 35 is provided in a front part of the cavity 32.

### Locking Projection

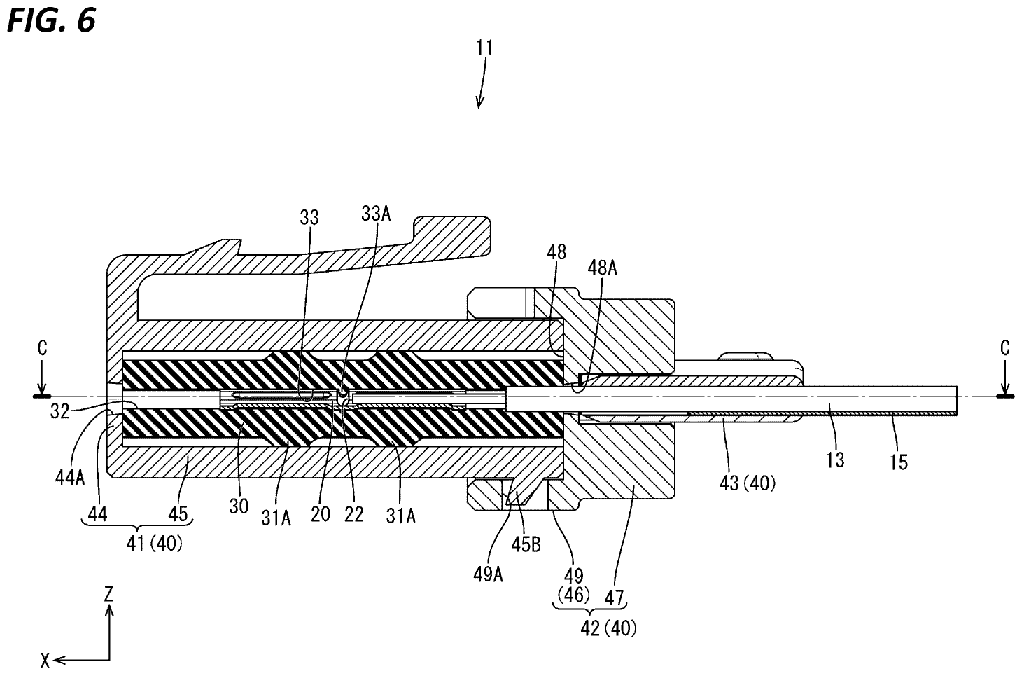

As shown in FIG. 6, the terminal accommodating portion 33 includes a locking projection 33A projecting inwardly of the cavity 32 from the inner peripheral surface of the cavity 32. The locking projection 33A is locked to the locking recess 22 of the terminal 20.

### First Sealing Portion, Second Sealing Portion

As shown in FIG. 9, a first sealing portion 36 to be held in close contact with the outer peripheral surface of the first insulation coating 13B is formed on the inner peripheral surface of the cavity 32 constituting the first wire inserting portion 34. In this way, water intrusion into the cavity 32 from behind the cavity 32 is prevented. Similarly, a second sealing portion 37 to be held in close contact with the outer peripheral surface of the second insulation coating 14B is formed on the inner peripheral surface of the cavity 32 constituting the second wire inserting portion 35. In this way, water intrusion into the cavity 32 from front of the cavity 32 is prevented.

In this embodiment, the second sealing portion 37 is disposed inside the connector 11. Thus, the connector assembly 10 can exhibit waterproofness even if a sealing ring for sealing connection surfaces of the connector 11 and the mating connector 12 is not provided. Further, the rubber plug 30 includes both the first sealing portions 36 and the second sealing portions 37. Therefore, the number of components of the connector assembly 10 can be suppressed, and the configuration of the connector assembly 10 can be simplified.

On the other hand, unlike this embodiment, a sealing ring for sealing connection surfaces of a male connector and a female connector needs to be provided to provide waterproofness for a connector assembly provided with the male connector including male terminals and the female connector including female terminals. Further, each connector needs to be provided with a sealing portion for sealing each wire.

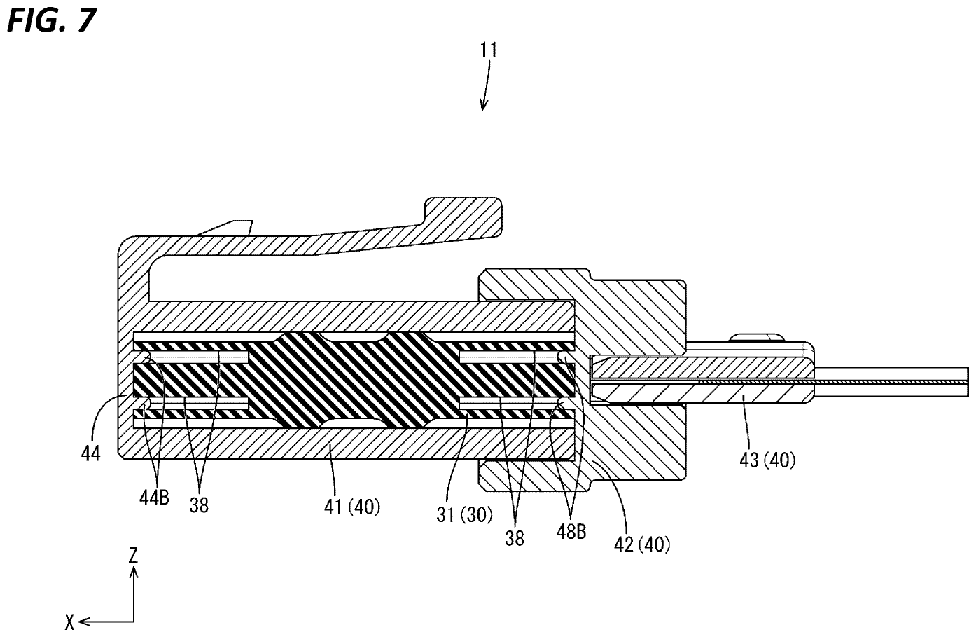

As shown in FIG. 13, the rear surface of the body portion 31 of the rubber plug 30 is provided with a plurality of engaging recesses 38 recessed forward from the rear surface. The engaging recesses 38 are disposed at positions shifted upward and downward with respect to the cavities 32. As shown in FIG. 7, the front surface of the body portion 31 is similarly provided with a plurality of engaging recesses 38 recessed rearward from the front surface.

### Housing

The housing 40 is made of insulating synthetic resin. As shown in FIG. 6, the housing 40 of this embodiment is provided with a rubber plug accommodating portion 41 for accommodating the rubber plug 30, a rear holder 42 for retaining the rubber plug 30 in the rubber plug accommodating portion 41 and the aforementioned first wire holding portion 43.

### Rubber Plug Accommodating Portion

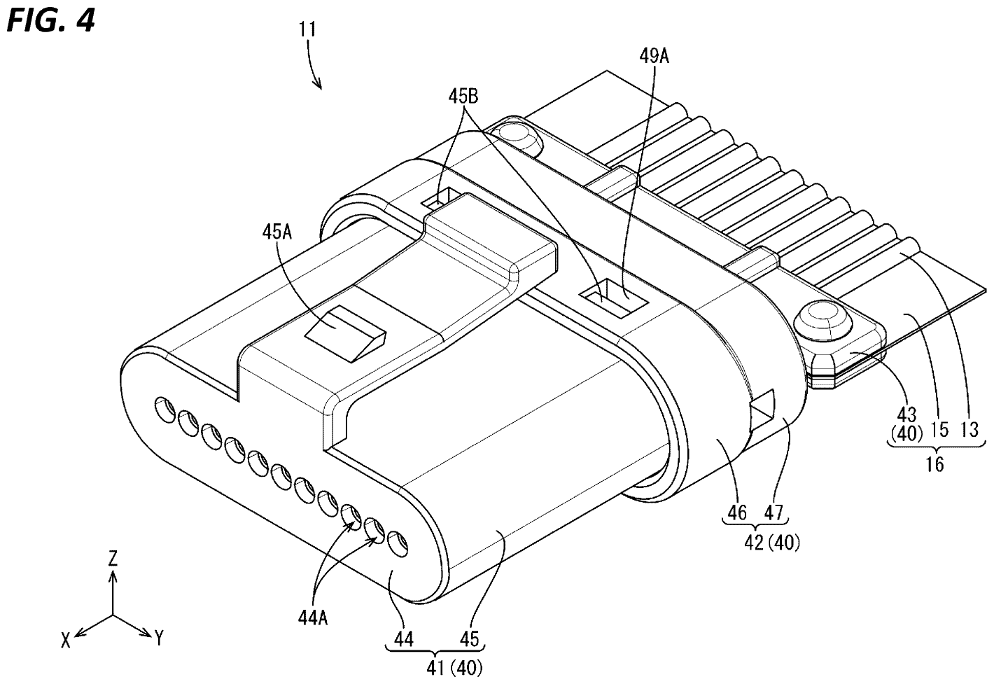

The rubber plug accommodating portion 41 has a substantially tubular shape. As shown in FIG. 4, the rubber plug accommodating portion 41 is provided with a front wall 44 and a peripheral wall 45 extending rearward from an outer edge part of the front wall 44. As shown in FIG. 6, the projections 31A of the rubber plug 30 are held in close contact with the inner peripheral surface of the peripheral wall 45. The front wall 44A is formed with a plurality of wire insertion holes 44A penetrating in the front-rear direction. The wire insertion holes 44A are disposed at positions corresponding to the cavities 32 of the rubber plug 30 accommodated in the rubber plug accommodating portion 41. The inner wall of the wire insertion hole 44A is inclined to increase an inner diameter of the wire insertion hole 44A toward a front side. In this way, the second wire 14 is easily guided into the wire insertion hole 44A (see FIG. 9).

As shown in FIG. 9, the rubber plug accommodating portion 41 is provided with a fitting lock portion 45A atop the peripheral wall 45. The fitting lock portion 45A is locked to a fitting lock receiving portion 66 of the mating housing 60. Lock projections 45B are formed to project outward on the outer surface of the peripheral wall 45. One lock projection 45B is provided on the outer surface of a lower side of the peripheral wall 45. As shown in FIG. 4, two lock projections 45B are provided on the outer surface of an upper side of the peripheral wall 45.

### Rear Holder

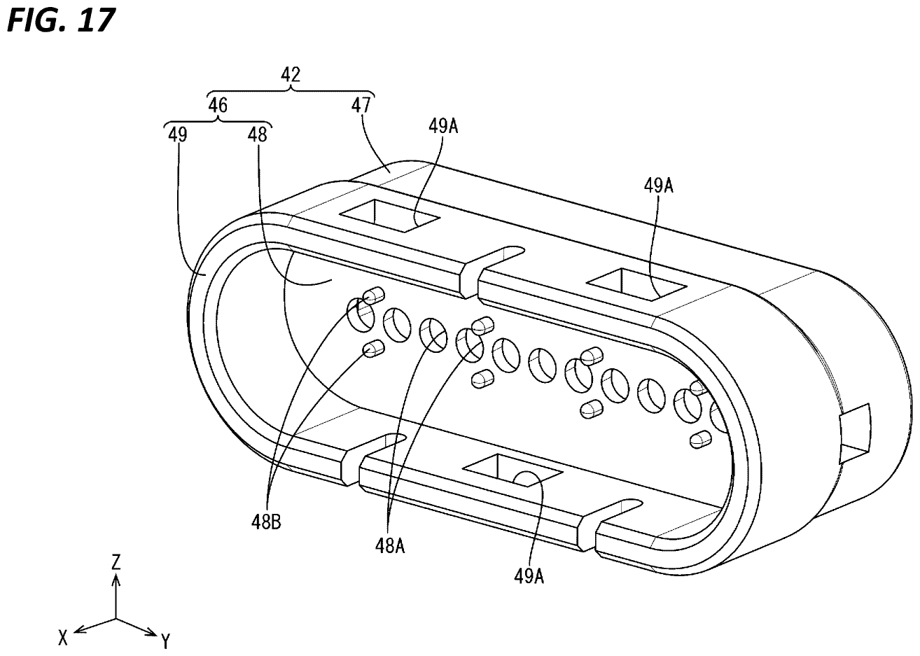

As shown in FIG. 17, the rear holder 42 includes a retaining tube portion 46 and a wire holding portion receiving portion 47. The retaining tube portion 46 has a substantially tubular shape. The retaining tube portion 46 includes a back wall 48 and a surrounding wall 49 extending forward from an outer edge part of the back wall 48. As shown in FIG. 6, the retaining tube portion 46 is fit to the rubber plug accommodating portion 41 from behind to prevent the rubber plug 30 in the rubber plug accommodating portion 41 from coming out rearward. The surrounding wall 49 is provided with lock receiving portions 49A to be locked to the lock projections 45B. The back wall 48 is formed with a plurality of openings 48A penetrating in the front-rear direction. The openings 48A are disposed at positions corresponding to the cavities 32. The inner wall of each opening 48A is inclined to increase an inner diameter of the opening 48A toward a rear side. In this way, the first wire 13 is easily guided into the opening 48A.

As shown in FIG. 17, the rear holder 42 includes engaging protrusions 48B projecting forward from the back wall 48. As shown in FIG. 7, the engaging protrusions 48B are engaged with the engaging recesses 38 provided in the rear surface of the rubber plug 30. Further, the rubber plug accommodating portion 41 is similarly provided with engaging protrusions 44B projecting rearward from the front wall 44. The engaging protrusions 44B are engaged with the engaging recesses 38 provided in the front surface of the rubber plug 30. The rubber plug 30 can be positioned in the rubber plug accommodating portion 41 by the engagement of the engaging protrusions 44B, 48B and the engaging recesses 38.

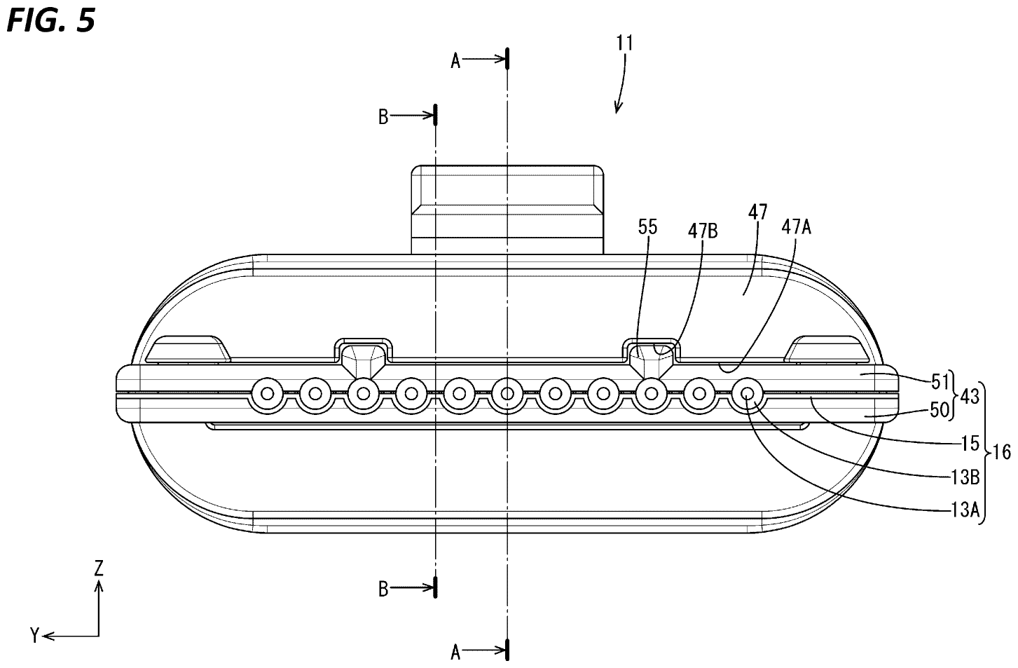

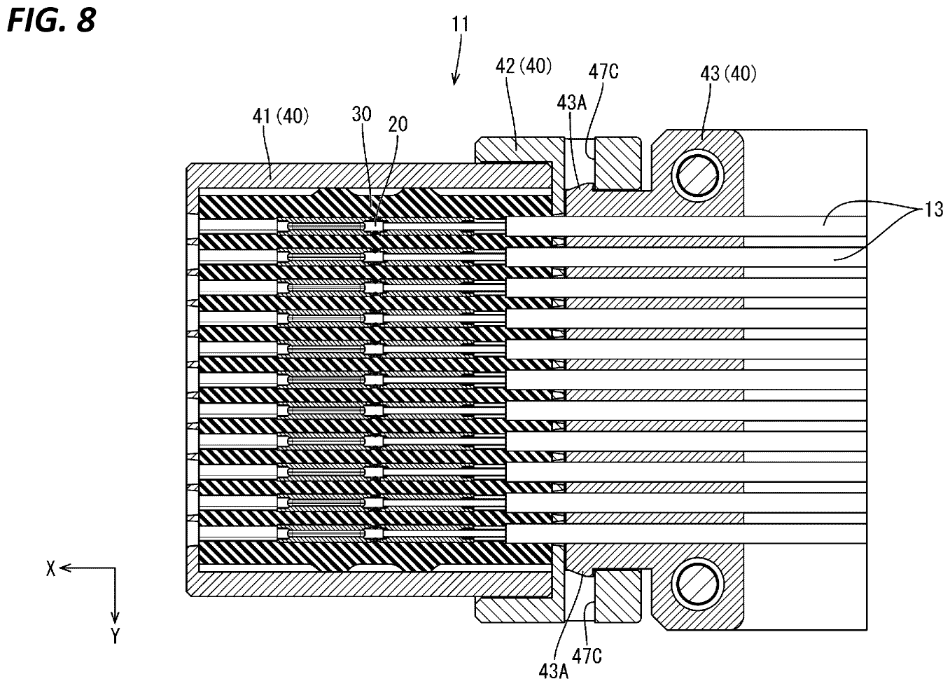

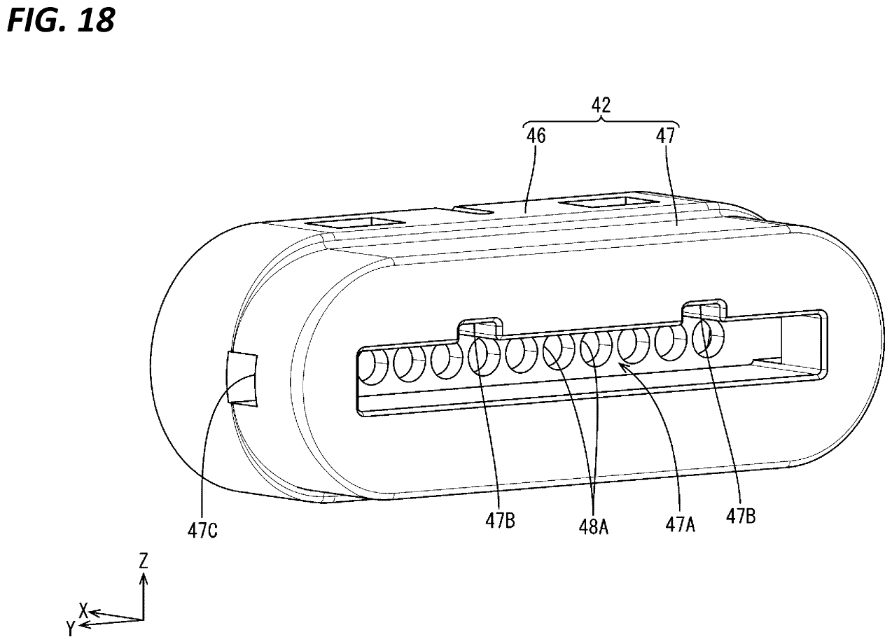

As shown in FIG. 18, the wire holding portion receiving portion 47 is disposed behind the retaining tube portion 46. The wire holding portion receiving portion 47 includes an insertion space 47A. The insertion space 47A communicates with the plurality of openings 48A. Two ridge portion receiving portions 47B are provided by being recessed upward in an upper wall part of the wire holding portion receiving portion 47. Locking holes 47C are formed to penetrate through left and right wall parts of the wire holding portion receiving portion 47 in the lateral direction. As shown in FIG. 5, the first wire module 16 is inserted into the insertion space 47A of the wire holding portion receiving portion 47. The ridge portion receiving portions 47B slide in contact with the ridge portions 55, thereby guiding the insertion of the first wire module 16. As shown in FIG. 8, the inner wall of the locking hole 47C is locked to the locking portion 43A.

### Mating Housing

The mating housing 60 is made of insulating synthetic resin. As shown in FIG. 3, the mating housing 60 of this embodiment is provided with a receptacle 61 and the aforementioned second wire holding portion 62. The receptacle 61 includes a fitting tube portion 63 and a wire holding portion receiving portion 64. The fitting tube portion 63 has a substantially tubular shape. A plurality of openings 65A are formed to penetrate through a back wall 65 of the fitting tube portion 63 in the front-rear direction. The second wires 14 inserted through the respective openings 65A are disposed to extend rearward in the fitting tube portion 63.

As shown in FIG. 9, the fitting tube portion 63 is fit to the rubber plug accommodating portion 41 from front. The receptacle 61 is provided with the fitting lock receiving portion 66 to be locked to the fitting lock portion 45A.

The wire holding portion receiving portion 64 is disposed in front of the fitting tube portion 63. As shown in FIG. 1, the wire holding portion receiving portion 64 is configured similarly to the wire holding portion receiving portion 47 of the rear holder 42 and includes an insertion space 47A, ridge portion receiving portions 47B and locking holes 47C. The second wire module 17 is inserted into the insertion space 47A of the wire holding portion receiving portion 64.

### Concerning Assembly Processes of Connector and Connector Assembly

Next, examples of assembly processes of the connector 11 and the connector assembly 10 according to this embodiment are described.

First, the terminals 20 are inserted into the cavities 32 of the rubber plug 30. By locking the locking projection 33A and the locking recess 22, the terminal 20 is disposed at a proper position of the terminal accommodating portion 33 in the cavity 32.

The rubber plug 30 accommodating the terminals 20 is accommodated into the rubber plug accommodating portion 41. At this time, the projections 31A of the rubber plug 30 are provided to project outward from the outer peripheral surface of the body portion 31 and contact the inner peripheral surface of the rubber plug accommodating portion 41. Thus, the rubber plug 30 is easily inserted into the rubber plug accommodating portion 41 as compared to the case where the projections 31A are not provided and the entire outer peripheral surface of the body portion 31 contacts the inner peripheral surface of the rubber plug accommodating portion 41.

Subsequently, the rear holder 42 is assembled with the rubber plug accommodating portion 41 from behind. The retaining tube portion 46 is fit to a rear part of the rubber plug accommodating portion 41 from outside. The lock receiving portions 49A and the lock projections 45A are locked. The rubber plug 30 is retained in the rubber plug accommodating portion 41 not to come out rearward by the back wall 48.

The first core wires 13A are exposed over a predetermined length in end parts of the first wires 13. With the plurality of first wires 13 arranged in the lateral direction to dispose the first core wires 13A in front end parts, the plurality of first wires 13 are collectively fixed by the fixing member 15. The lower holding portion 50 is integrally formed to the fixing member 15. The holding projections 53 of the lower holding portion 50 are inserted into the insertion holes 54B of the upper holding portion 51 to sandwich the plurality of first wires 13 by the lower and upper holding portions 50, 51. In this way, the first wire module 16 is configured.

The first wire module 16 is inserted into the insertion space 47A of the wire holding portion receiving portion 47. The first core wires 13A are inserted into the openings 48A and subsequently inserted into the cavities 32.

If the first wire 13 is pushed further forward, the first core wire 13A enters the tubular portion 21 of the terminal 20. By the contact of the first core wire 13A with the projecting portions 25, the first wire 13 is electrically connected to the terminal 20. Since being a single-core wire, the first core wire 13A is easily inserted into the cavity 32 and the tubular portion 21 as compared to a core wire formed of a plurality of thin metal wires.

After the first core wire 13A enters the tubular portion 21, the first insulation coating 13B enters the cavity 32 through the opening 48A.

Further, if the first wire holding portion 43 enters the insertion space 47A, the ridge portion receiving portions 47B and the ridge portions 55 slide in contact, whereby the insertion of the first wire module 16 is guided. The locking portions 43A and the inner walls of the locking holes 47C are locked, and the first wire holding portion 43 is disposed at a proper position of the wire holding portion receiving portion 47. Further, the first wires 13 are disposed at proper positions of the first wire inserting portions 34 in the cavities 32, and the outer peripheral surfaces of the first wires 13 are sealed by the first sealing portions 36.

In the above way, the assembly of the connector 11 is completed.

The second wire module 17 is configured, similarly to the first wire module 16. The second wire module 17 is inserted into the insertion space 47A of the wire holding portion receiving portion 64. The second wires 14 are inserted into the openings 65A.

If the second wire holding portion 62 enters the insertion space 47A, the ridge portion receiving portions 47B and the ridge portions 55 slide in contact, whereby the insertion of the second wire module 17 is guided. The locking portions 43A and the inner walls of the locking holes 47C are locked, and the second wire holding portion 62 is disposed at a proper position of the wire holding portion receiving portion 64.

In the above way, the assembly of the mating connector 12 is completed.

The mating connector 12 is connected to the connector 11 from front. The second wires 14 are inserted into the wire insertion holes 44A and subsequently inserted into the cavities 32.

If the second core wires 14A enter the cavities 32, the receptacle 61 starts to be fit to the rubber plug accommodating portion 41 from outside. If the connection of the connector 11 and the mating connector 12 further proceeds, the second core wires 14A enter the tubular portions 21 of the terminals 20. By the contact of the second core wire 14A with the projecting portions 25, the second wire 14 is electrically connected to the terminal 20. Since being a single-core wire, the second core wire 14A is easily inserted into the cavity 32 and the tubular portion 21 as compared to a core wire formed of a plurality of thin metal wires.

After the second core wire 14A enters the tubular portion 21, the second insulation coating 14B enters the cavity 32 through the wire insertion hole 44A.

By locking the fitting lock receiving portion 66 of the receptacle 61 and the fitting lock portion 45A of the rubber plug accommodating portion 41, the connection of the connector 11 and the mating connector 12 is completed. The second wire 14 is disposed at a proper position of the second wire inserting portion 35 in the cavity 32, and the outer peripheral surface of the second wire 14 is sealed by the second sealing portion 37.

In the above way, the assembly of the connector assembly 10 is completed.

### Functions and Effects of Embodiment

According to the embodiment, the following functions and effects are achieved.

The connector 11 according to this embodiment is to be connected to the second wires 14 and provided with the first wires 13, the terminals 20, the rubber plug 30 and the housing 40 for accommodating the rubber plug 30. The first wire 13 is provided with the first core wire 13A and the first insulation coating 13B covering the first core wire 13A. The second wire 14 is provided with the second core wire 14A and the second insulation coating 14B covering the second core wire 14A. The terminal 20 includes the first connecting portion 23 to be connected to the first core wire 14A and the second connecting portion 24 to be connected to the second core wire 14A. The rubber plug 30 is formed with the cavities 32 extending in a first direction (front-rear direction), the terminal 20, the first wire 13 and the second wire 14 being inserted into each cavity 32. The first sealing portion 36 disposed on one side (rear side) in the first direction with respect to the terminal 20 to seal the outer peripheral surface of the first insulation coating 13B and the second sealing portion 37 disposed on the other side (front side) in the first direction with respect to the terminal 20 to seal the outer peripheral surface of the second insulation coating 14B are formed on the inner peripheral surface of the cavity 32.

According to this configuration, the terminal 20, the first wire 13 and the second wire 14 are inserted into the cavity 32 of the rubber plug 30, and the first and second sealing portions 36, 37 are provided on the inner peripheral surface of the cavity 32. Thus, the connector 11 can be provided with waterproofness while an increase in the number of components is suppressed.

In the embodiment, the rubber plug 30 includes the locking projections 33A projecting inwardly of the cavities 32 from the inner peripheral surfaces of the cavities 32, and the terminal 20 includes the locking recess 22 to be locked to the locking projection 33A.

According to this configuration, the terminal 20 is easily held in the cavity 32 by locking the locking projection 33A and the locking recess 22.

In the embodiment, the rubber plug 30 includes the projections 31A projecting from the outer peripheral surface of the rubber plug 30 to contact the inner peripheral surface of the housing 40.

According to this configuration, a contact area of the outer peripheral surface of the rubber plug 30 and the inner peripheral surface of the housing 40 can be reduced by providing the projections 31A on the outer peripheral surface of the rubber plug 30. Thus, an insertion force for inserting the rubber plug 30 into the housing 40 can be reduced.

In the embodiment, the housing 40 includes the rubber plug accommodating portion 41 for accommodating the rubber plug 30 and the rear holder 42 for retaining the rubber plug 30 inside the rubber plug accommodating portion 41 by being assembled with the rubber plug accommodating portion 41 from the one side in the first direction.

According to this configuration, the rubber plug 30 is easily accommodated into the housing 40.

In the embodiment, the housing 40 includes the first wire holding portion 43 for holding the first wires 13 by being assembled with the rear holder 42.

According to this configuration, the first wires 13 are easily held in the housing 40.

In the embodiment, the first and second core wires 13A, 14A are single-core wires.

According to this configuration, since being single-core wires, the first and second core wires 13A, 14A are easily inserted into the cavities 32.

In the embodiment, the terminal 20 includes the tubular portion 21 long in the first direction and the projecting portions 25 projecting inwardly of the tubular portion 21 from the inner surface of the tubular portion 21, and the first and second connecting portions 23, 24 include the projecting portions 25.

According to this configuration, the terminal 20 and the first and second core wires 13A, 14A are easily connected by inserting the first and second core wires 13A, 14A into the tubular portion 21. Further, since the first and second connecting portions 23, 24 are configured to include the projecting portions 25, contact areas of the first and second core wires 13A, 14A with the inner surface of the tubular portion 21 can be reduced. Thus, insertion forces for inserting the first and second core wires 13A, 14A into the tubular portion 21 can be reduced.

The connector assembly 10 of this embodiment is provided with the connector 11 and the mating connector 12 to be connected to the connector 11, and the mating connector 12 includes the second wires 14 and the mating housing 60 for holding the second wires 14.

According to this configuration, the connector assembly 10 can be provided with waterproofness while an increase in the number of components is suppressed.

### Other Embodiments

(1) Although the first and second core wires 13A, 14A are single-core wires in the above embodiment, there is no limitation to this and at least one of the first and second core wires 13, 14 may be formed of a plurality of thin metal wires.

(2) Although the terminal 20 includes the tubular portion 21 in the above embodiment, there is no limitation to this and a terminal may not have a tubular shape.

(3) Although each of the first and second connecting portions 23, 24 is composed of three projecting portions 25 in the above embodiment, there is no limitation to this. For example, at least one of first and second connecting portions may be composed of projecting portions and the inner surface of a tubular portion or may not include the projecting portions.

(4) Although the connector 11 is provided with the plurality of first wires 13 in the above embodiment, there is no limitation to this and a connector may be provided with one first wire.

(5) Although the first wire module 16 is provided with the fixing member 15 and the first wire holding portion 43 in the above embodiment, there is no limitation to this. For example, a first wire module may include no fixing member. Further, a first wire holding portion may be constituted by one member and integrally formed with a plurality of first wires.

### LIST OF REFERENCE NUMERALS

10: connector assembly
11: connector
12: mating connector
13: first wire
13A: first core wire
13B: first insulation coating
14: second wire
14A: second core wire
14B: second insulation coating
15: fixing member
15A: through hole
16: first wire module
17: second wire module
20: terminal
21: tubular portion
22: locking recess
23: first connecting portion
24: second connecting portion
25: projecting portion
26: recess
30: rubber plug
31: body portion
31A: projection
32: cavity
33: terminal accommodating portion
33A: locking projection
34: first wire inserting portion
35: second wire inserting portion
36: first sealing portion
37: second sealing portion
38: engaging recess
40: housing
41: rubber plug accommodating portion
42: rear holder
43: first wire holding portion
43A: locking portion
44: front wall
44A: wire insertion hole
44B: engaging protrusion
45: peripheral wall
45A: fitting lock portion
45B: lock projection
46: retaining tube portion
47: wire holding portion receiving portion
47A: insertion space
47B: ridge portion receiving portion
47C: locking hole
48: back wall
48A: opening
48B: engaging protrusion
49: surrounding wall
49A: lock receiving portion
50: lower holding portion
51: upper holding portion
52: lower plate portion
53: holding projection
53A: shaft portion
53B: enlarged diameter portion
54: upper plate portion
54A: wire receiving portion
54B: insertion hole
55: ridge portion
60: mating housing
61: receptacle
62: second wire holding portion
63: fitting tube portion
64: wire holding portion receiving portion
65: back wall
65A: opening
66: fitting lock receiving portion

1. A connector to be connected to a second wire, comprising:
a first wire;
a terminal;
a rubber plug; and
a housing for accommodating the rubber plug,
the first wire including a first core wire and a first insulation coating covering the first core wire,
the second wire including a second core wire and a second insulation coating covering the second core wire,
the terminal including a first connecting portion to be connected to the first core wire and a second connecting portion to be connected to the second core wire,
the rubber plug being formed with a cavity extending in a first direction, the terminal, the first wire and the second wire being inserted inside the cavity, and
a first sealing portion disposed on one side in the first direction with respect to the terminal to seal an outer peripheral surface of the first insulation coating and a second sealing portion disposed on the other side in the first direction with respect to the terminal to seal an outer peripheral surface of the second insulation coating being formed on an inner peripheral surface of the cavity.

2. The connector of claim 1, wherein:
the rubber plug includes a locking projection projecting inwardly of the cavity from the inner peripheral surface of the cavity, and
the terminal includes a locking recess to be locked to the locking projection.

3. The connector of claim 1, wherein the rubber plug includes a projection projecting from an outer peripheral surface of the rubber plug to contact an inner peripheral surface of the housing.

4. The connector of claim 1, wherein the housing includes a rubber plug accommodating portion for accommodating the rubber plug and a rear holder for retaining the rubber plug inside the rubber plug accommodating portion by being assembled with the rubber plug accommodating portion from the one side in the first direction.

5. The connector of claim 4, wherein the housing includes a first wire holding portion for holding the first wire by being assembled with the rear holder.

6. The connector of claim 1, wherein the first core wire and the second core wire are single-core wires.

7. The connector of claim 1, wherein:
the terminal includes a tubular portion long in the first direction and a projecting portion projecting inwardly of the tubular portion from an inner surface of the tubular portion, and
the first and second connecting portions include the projecting portion.

8. A connector assembly, comprising:
the connector of claim 1; and
a mating connector to be connected to the connector,
the mating connector including the second wire and a mating housing for holding the second wire.
